(19) United States
(12) Patent Application Publication
(10) Pub. No.: US 2003/0172082 A1
(43) Pub. Date: Sep. 11, 2003

(54) Method and system for accessing action item information

(76) Inventors: Jeffrey Benoit, Palm City, FL (US); Tyler Jacobs, Greenville, SC (US); Joseph A. Kraft, Simpsonville, SC (US); Russell Arlie Martin, Simpsonville, SC (US); Mark Nichols, Simpsonville, SC (US); Keith Michael Parker, Greer, SC (US); Raja Subramanian, Bangalore (IN); Michael Sullivan, Anderson, SC (US)

Correspondence Address: PERKINS COIE LLP, PATENT-SEA, P.O. BOX 1247, SEATTLE, WA, 98111-1247, US

(21) Appl. No.: 10/093,098

(22) Filed: Mar. 6, 2002

(51) Int. Cl. G06F 7/00

(52) U.S. Cl. 707/101

(57) ABSTRACT

A method and system is provided that facilitates the access of stored action item information that is the product of an organizational review process. An action item tracking system provides categories of information relating to action items. Custom queries may be created to search for information stored in the action item tracking system. The custom queries may be generated using provided query creation options. The action item tracking system executes the custom queries in order to generate reports containing action item information. The reports are displayed to the user. The custom queries may be executed repeatedly at a frequency provided by the user so that new reports are created as information in the action item tracking system is periodically updated. Operations on report attributes may also be executed to obtain a result, and indications of whether the result falls outside of specified limits may be provided.

### TECHNICAL FIELD

The described technology relates generally to tracking information, and more particularly, to accessing action item information using custom search queries.

### BACKGROUND

Businesses that engage in research and development activities for products (e.g., physical products, services, and programs) may conduct formal reviews of the ideas and concepts formulated during such activities. For example, when a product design board formulates an idea for a new product, it is often desirable to conduct an early-stage review of the idea, focusing on aspects such as technical design, risk assessment, safety considerations, program aspects, or manufacturing feasibility. During the review process, one or more issues may be identified, along with corresponding action items that are needed to address the issues. These action items require resolution to ensure the success of the product being evaluated. Accordingly, some method may be used to track the status of action items.

In many cases, a large organization may track the issues and action items resulting from reviews by assigning due dates and risk levels. Typically, large numbers of action items may be generated in the review process, making tracking difficult. In many cases, individual groups or subgroups within the organization receive responsibility for the issues and actions items. Despite the use of such techniques, however, tracking issues and monitoring the status of action items can be problematic. For example, action items not resolved or completed on time can lead to test failures or rework in the factory or in unit failures in the field, resulting in large repair or rework costs. Unless there is some way to ensure that the appropriate individuals within the organization receive relevant information that action items are pending or overdue, the problems described above may likely occur, along with other problems such as duplicated efforts to address issues and action items. This is true especially with respect to large-scale projects. Additionally, individuals responsible for future development activities may miss opportunities to benefit from work performed on completed projects unless there is some way to easily access issue and action item information generated from past activities.

To address these problems, methods have been developed for storing and retrieving issue and action item information in a computer database. Because using a database to store information is alone not enough to ensure that various individuals and groups within a business organization have access to relevant issue and action item information, administrators within the organization may use conventional database searching techniques to retrieve and compile information. The administrators may then use this information to create customized reports. The reports may be created by manipulating database information using, for example, an Excel pivot table and plot charts. This practice, however, is time-consuming and labor-intensive, especially when different reports need to be generated for different individuals within the organization, and when reports need to be regenerated each time additional reviews take place or each time the status of an action item changes. Moreover, although systems exist that allow users to create queries to search action items databases (see U.S. Pat. No. 6,222,535), these systems are limited in their ability to provide regularly updated reports.

It would be desirable to have an action item tracking system that reduces the overall time and cost of generating personalized reports for individual users on a regularly scheduled basis.

### BRIEF DESCRIPTION OF THE DRAWINGS

FIGS. 1-9 are web pages that illustrate a user interface of an action item tracking system.

FIG. 10 is a block diagram illustrating an example of components of an action item tracking system.

FIG. 11 is a flow diagram illustrating a routine for processing a request for a search-by-due-date query option page in one embodiment.

FIG. 12 is a flow diagram illustrating a routine for processing an action event to execute a query in one embodiment.

FIG. 13 is a flow diagram illustrating a routine for generating a page to display reports resulting from an executed query.

FIG. 14 is a flow diagram illustrating a routine for generating a dial indication for an executed query.

FIG. 15 is a flow diagram illustrating a routine for editing a saved query in one embodiment.

FIG. 16 is a block diagram illustrating data structures of a sample database in one embodiment.

### DETAILED DESCRIPTION

A method and system for storing, retrieving, and presenting information to a user and, more specifically, for presenting information associated with issues and action items identified during a review process (herein, “action item information”), is described in detail herein. In one embodiment, action items are identified during formal reviews of ideas and concepts that are conceived by personnel during research and development activities. For example, a team of product developers may conceive an idea for a new product, such as a turbine for generating electricity. When a review board considers the details involved in designing the turbine, multiple issues and questions may arise, some quite detailed. For example, the strength of a particular size of turbine blade may require evaluation, as well as the material used for its construction. Typically each review process may result in numerous issues and questions. To ensure that issues are adequately addressed, an action item is created for each issue or question. Information corresponding to this action item is stored in a database or other information storage device that is part of an action item tracking system. This information might include, for example, the names of the personnel involved in resolution of the action item and dates associated with the action item.

One way in which a user accesses stored action item information is by providing a customized selection of retrieval criteria, or parameters, in order to create custom queries. A server component of the action item tracking system then generates a report to display custom query results. In one embodiment, criteria for a custom query may be inputted by the user via a selection of standardized or partially standardized input fields (e.g., text fields, pull-down menus, text areas, radio buttons, etc.) that are provided in one or more query option web pages. For example, an engineer may enter query criteria into text fields on a web page, indicating that she wants to retrieve information associated with action items due on a given date. Once submitted, the action item tracking system uses the criteria to periodically search for, retrieve, and display in a report information associated with those action items. Similarly, a product manager may input search query criteria that cause the action item tracking system to search for, retrieve, and display, in a report, all open item information associated with the various product lines under his management.

In one embodiment, a user's inputted custom query criteria may be saved as part of a personal navigation tool (e.g., personal cockpit). The saved queries may then be executed repeatedly at a scheduled time interval (e.g., daily, weekly, or monthly). Each time a saved query is executed, a new report containing the query results is generated and displayed to the user. To implement this scheduled execution feature, the user may provide the action item tracking system with indications of a frequency for executing a query. For example, while creating a custom query, the user may provide an indication that causes the server to execute a query on a daily, weekly, or monthly basis. Alternatively, a query may be set to execute each time that the user logs in to the system. In this way, the user may continually monitor action item information that is frequently updated or modified. This ongoing ability to monitor action items is especially useful when multiple individuals have authority to modify the status of action items.

Information corresponding to action items may consist of several information fields (e.g., identification number, status, due date, closing date, owner information, risk level, brief description, project name, etc.). In one embodiment, while constructing a custom query, a user may provide indications of the information fields that the user desires to have displayed in the report that the action item tracking system will create to display the query results. For example, as part of the criteria for a custom query, the user may provide indications to include only due-date and action item status information in the reports associated with the custom query.

As part of the report generation process, the action item tracking system may perform calculations on information contained within the reports that display query results. For example, the action item tracking system may add the number of action items assigned to each action item owner displayed in a report containing query results. Similarly, the action item tracking system may count the number of highest risk overdue action items, (e.g., red) returned in a query result. In one embodiment, when the result of the calculation exceeds a specified limit provided by the user, the action item tracking system provides a presentation image (e.g., an icon) that indicates that the result is out of spec. This draws the user's attention to the particular report containing the out of spec result and facilitates “management by exception” by calling the user's attention to more urgent query results.

Reports generated to display the results of an executed custom query may be displayed to the user using various techniques. For example, complete reports may be displayed on a user's custom home page. Alternatively, a condensed version of a report may be displayed on the user's home page, along with a link to a web page containing a more detailed version of the report. In one embodiment, the user accesses report web pages via a URL (uniform resource locator) link from the user's home page. The display of reports via web pages may be implemented using, for example, XML (extensible markup language) or HTML (hypertext markup language) scripts that provide information to a user. In one embodiment, the user may customize the type of information that is displayed on the user's home page, as well as the manner in which it is displayed by providing home page display preferences.

In another embodiment, a user may receive reports or query results in an electronic mail format. Reports may be generated using other formats as well. While one or more ways of displaying information to users in pages are shown and described herein, those skilled in the relevant art will recognize that various other alternatives may be employed, such as the WAP (wireless access protocol), or other formats such as character/code-based formats, algorithm-based formats (e.g., vector-generated), or matrix or bitmap formats.

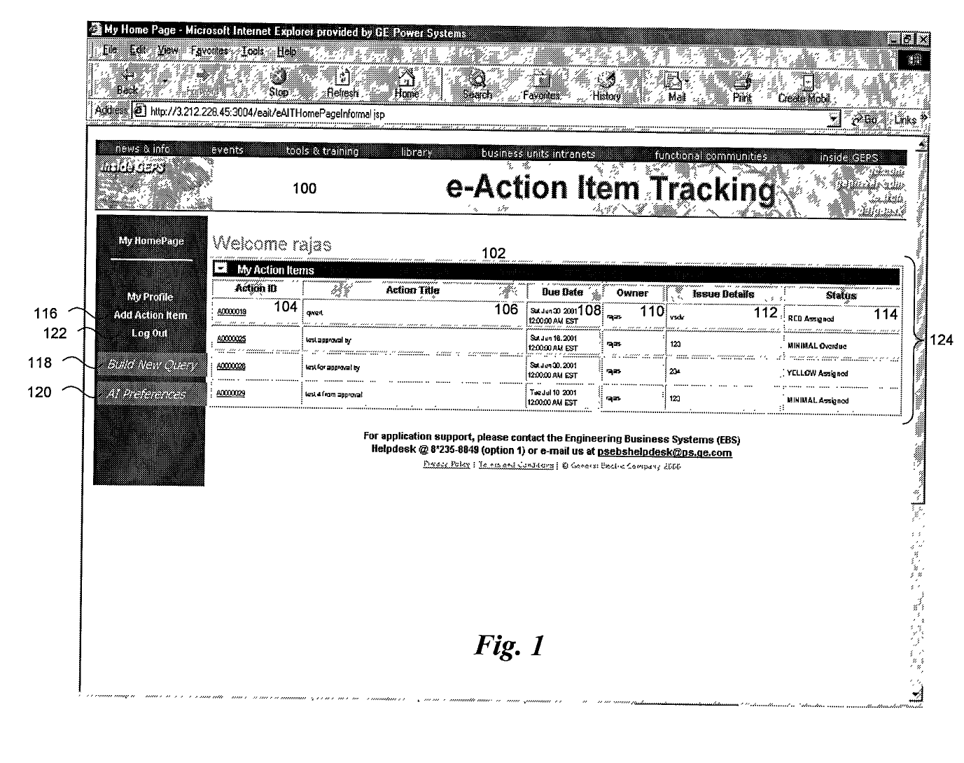

FIGS. 1-9 are web pages that illustrate a user interface of the action item information retrieval system in one embodiment. The terms “screen,” “web page,” and “page” are generally used interchangeably herein. The web pages shown herein provide facilities to receive input data, such as in the form of text fields to be filled in, drop-down menus for entries allowing one or more of several entries to be selected, buttons, radio buttons, sliders, or other known user interface tools for receiving user input in a web page. In general, a “link” refers to any resource locator identifying a resource on a network, such as a display description provided by an organization having a site or node on the network. The web pages are stored as display descriptions, graphical user interfaces, or other methods of depicting information on a computer screen where the layout and information or content to be displayed on the page is stored in a database. While aspects of the invention are described using a network environment, some or all features may be implemented within a single-computer environment.

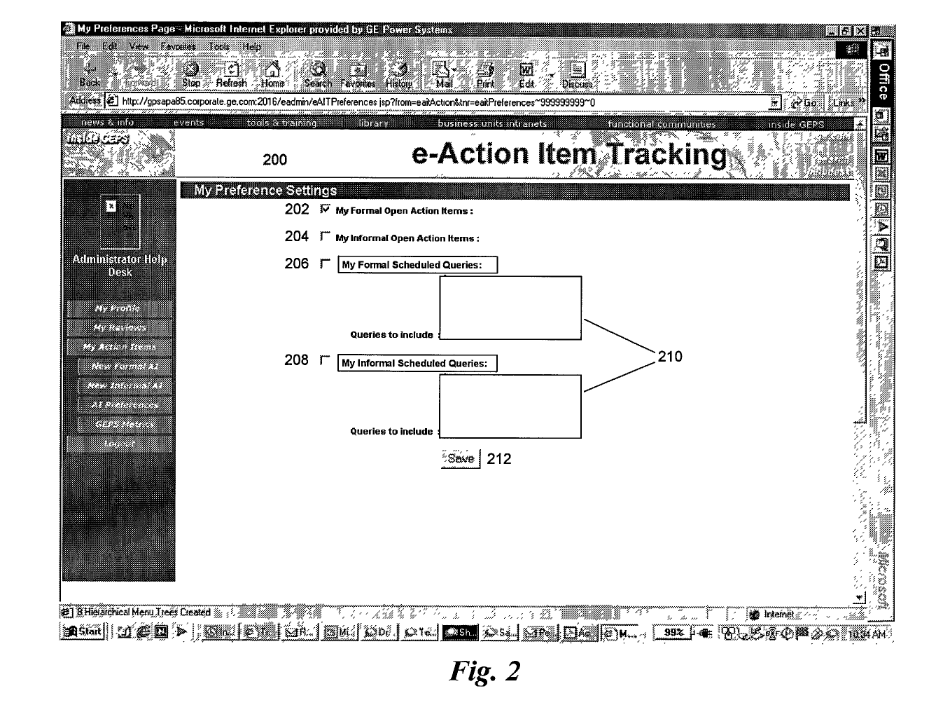

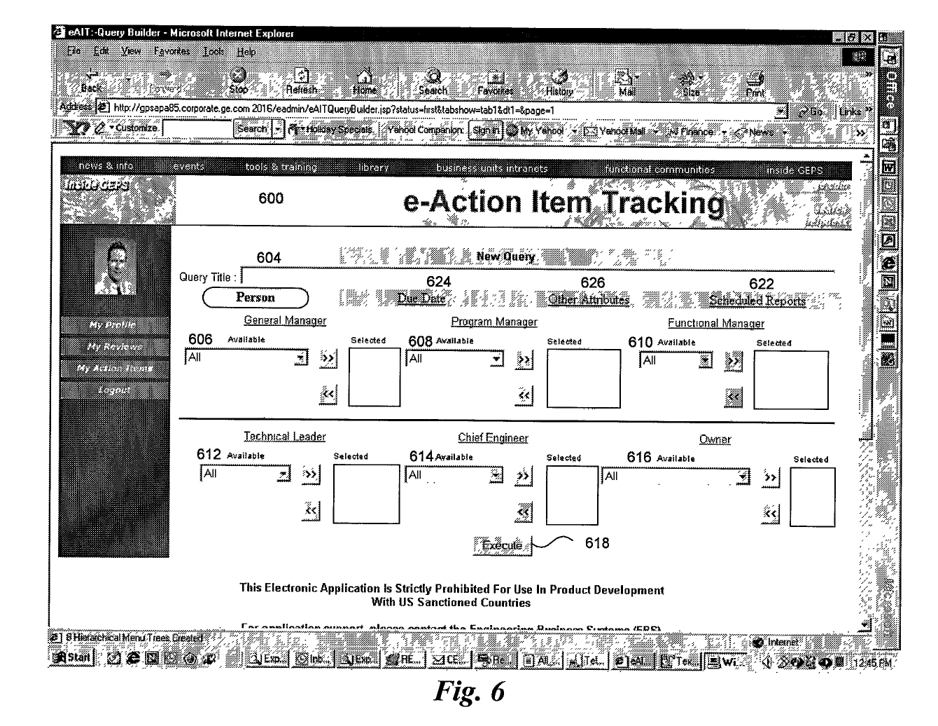

FIG. 1 illustrates a personalized home page for a user of the action item tracking system. The home page 100 includes a build query link 118. Selection of the build new query link 118 causes the display of a query option page, such as one of the query option pages of FIGS. 6-8. The user may use the query option pages to create new queries. Selection of an add action item link 116 causes the display of a page that allows the user to input new action item information into the action item tracking system. Selection of a preferences link 120 causes the display of a preferences page, such as the preferences page 200 of FIG. 2. The user may customize the information (e.g., reports) displayed in the home page by indicating display preferences via the preferences page 200. The home page 100 also includes a log out link 122, which enables the user to log out of the action item tracking system.

The display area 102 is available for displaying quickly viewed information related to the user's action items, and scheduled reports (herein “flash reports” or “quick-view reports”). In this particular example, the user has customized the home page so that it displays a “My Action Items” flash report 124. The displayed flash report 124, which includes a list of the action items owned by the user of the customized home page 100, is generated each time the user logs in to the system. In this example, the displayed flash report 124 includes an action item identification number 104, a title 106, a due date 108, an owner name 110, issue details 112, and a status 114 for each listed action item. Although not illustrated in this example, other home page display preferences are possible. For example, the home page 100 may display scheduled query flash reports. Unlike the standardized “My Action Items” flash report 124 described in the preceding paragraph, scheduled query reports are generated when the action item tracking system executes one of the user's saved custom queries.

FIG. 2 is an example of a preferences page through which a user may customize the information displayed in the user's personal home page. The preferences page 200 includes checkboxes that the user may select to indicate the report types to be displayed in the user's home page (e.g., formal open action items 202, informal open action items 204, formal scheduled queries 206, and informal scheduled queries 208). In this embodiment, action items and saved queries may be either formal or informal. The formal action items are the product of formal reviews while the informal action items are the product of informal reviews. Formal action items are tracked more rigorously than informal action items. Formal queries retrieve formal action item information while informal queries retrieve informal action item information.

In this embodiment, if the user selects to display open action items (either formal 202 or informal 204), a flash report listing the user's owned action items is displayed on the user's home page. The displayed flash report is similar to the flash report illustrated in the display area 102 of FIG. 1. If the user selects to display scheduled query reports (either formal or informal) on the user's home page, the user may further select specific saved queries from a menu 210 containing all of the user's saved queries. The user saves entered preferences by selecting a save button 212. When the save button 212 is selected, the user's home page is displayed, showing the information indicated by the user's selected preferences. Selected preferences are saved in a preferences store within the action item tracking system.

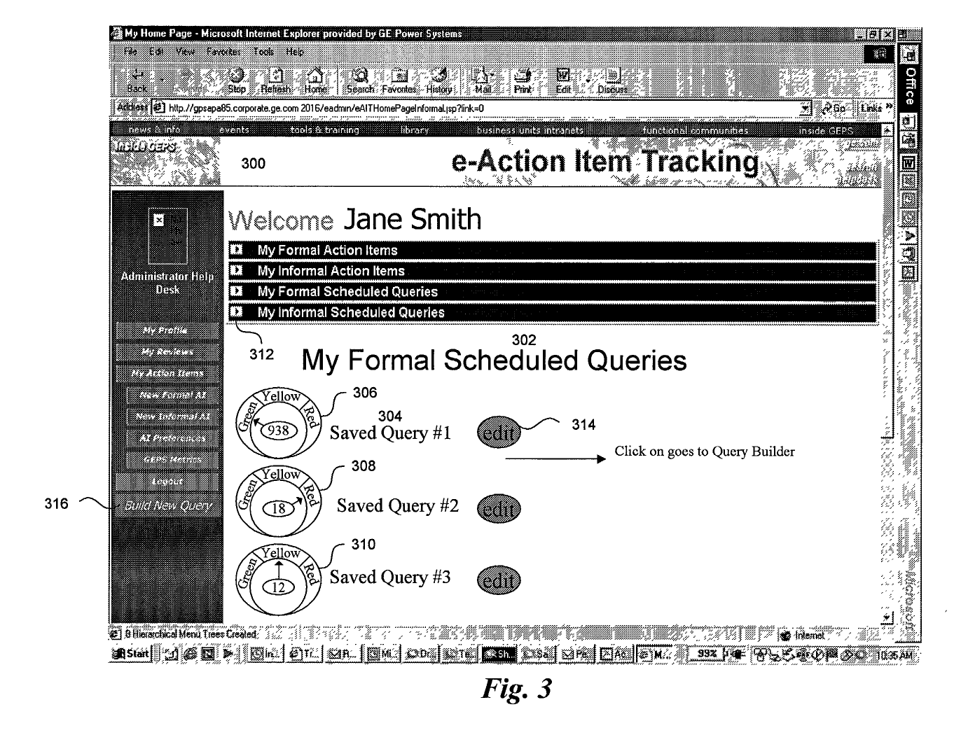

In FIG. 2, the formal open action items field 202 is selected. If the preferences are saved in this state, the user's home page will display information in a manner similar to the user home page 100 of FIG. 1, showing only the user's open action items in a flash report. If the user selects all the fields on the preferences page 200, including the informal open action items 204 field, the formal scheduled queries field 206, and the informal scheduled queries field 208, the user's home page will display information in a manner similar to the home page 300 depicted in FIG. 3.

FIG. 3 is an example of a personalized home page for another user of the action item tracking system. The home page 300 in this example displays four report types, including the user's formal and informal action items, as well as the user's formal and informal scheduled queries. The user in this example has customized the home page to display the four report types by using a preferences page similar to the preferences page 200 of FIG. 2. In this embodiment, an expanded view of the user's formal scheduled queries is shown in the display area 302. The other selected report types (e.g., formal action items, informal action items, and informal scheduled queries) remain unexpanded, but may be viewed by selecting a corresponding expansion arrow 312. In other embodiments, expanded views of the entire collection of selected report types are presented simultaneously in the display area 302. The user may edit a saved query by selecting a corresponding edit link 308. The user may build a new query by selecting the build new query link 316, which causes the display of page that allows the user to build a new query, such as the query option pages of FIGS. 6-8.

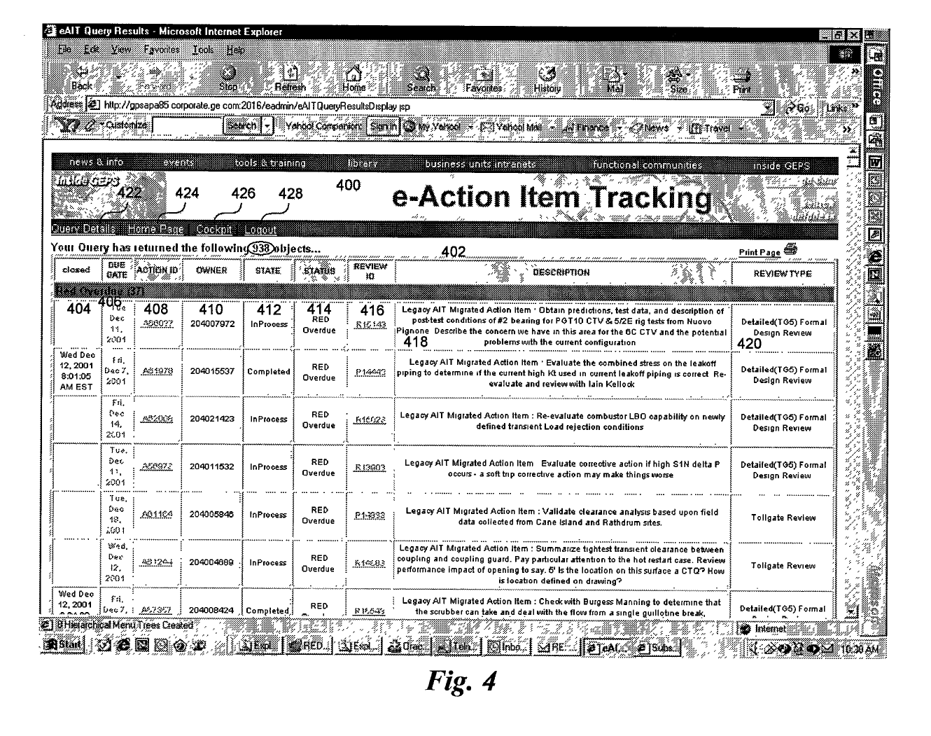

In this example, the flash report displayed in the display area 302 includes a list of three scheduled queries. The user selects the scheduled queries that appear on the home page 300 from a menu of saved queries presented on the preferences page 200 of FIG. 2. Each query list item includes a query title 304 and a query dial 306. The query dial 306 functions both as an indicator and a link, which if selected by the user, causes the display of query report page, such as the query report page 400 of FIG. 4.

The query dials 306, 308, and 310 in this illustration are examples of presentation images that provide an indication to the user of some attribute of the report. In this embodiment, each dial icon indicates the number of action items returned by the query (e.g., 938 for the first saved query), as well as the whether some aspect of the query result is out of spec. For example, if the number of overdue action items returned in a particular query result exceeds a yellow dial limit value specified by the user (e.g., 15 action items), the needle on the dial corresponding with that query will point to a red zone, as depicted in the dial 308 corresponding with the second saved query. Similarly, if the number of overdue action items returned in the query is between the specified yellow dial limit (e.g., 15 action items) and a specified green dial limit (e.g., 10 action items) the needle on the dial will point to a yellow zone, as depicted in the dial 310 associated with the third saved query.

Although the monitored attribute described in detail herein relates to overdue action items, one skilled in the art would appreciate that a presentation image, such as a dial, thermometer, photo icon, or any type of descriptive image, may be used as an indicator for any attribute, user-defined limit, user-defined specification, or result that corresponds with an executed query. For example, a query relating to quarterly sales report may track the number of sales made by each sales representative listed in the report. If a particular sales representative exceeds a user-defined limit for sales, the user may select to have a photo icon of the sales representative displayed with an indication of the query results. In another example, a user may set user-defined limits for average losses in a daily stock report. If the losses exceed the specified limit, then a sell icon may appear along side a description of the report. In one embodiment, the SELL icon will function as a link to the stock report. In another embodiment, the SELL icon will function as a link to a web page through which the user may sell or by stocks on-line.

FIG. 4 is an example of a query report page. In this embodiment, the action item tracking system displays the query report page 400 when the user selects a query results link from a saved queries display, such as the query results link 304 displayed in the home page 300 of FIG. 3. In this embodiment, the action item tracking system may also display a query report page when the user directly submits a custom query for execution from a query option page, such as the query option pages of FIGS. 6-8. In other embodiments, the contents of a query report page may be sent to the user via, for example, an electronic mail message.

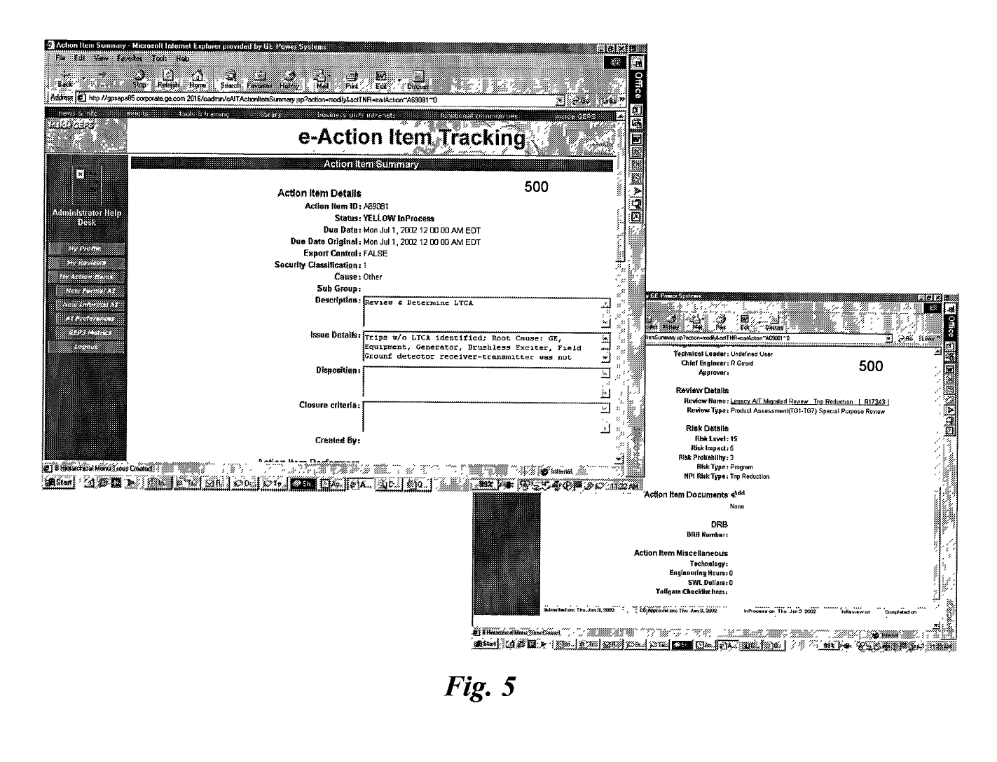

In this particular example, the query report page 400 displays information for 938 action items. The information for each action item includes a closed date 404 on which the action item was closed. A due date 406 is also provided, which specified the date on which the action item is due for completion. An action item identification number 408, which functions as URL link to another web page that displays more detailed information about the action item, such as the action item detail page 500 of FIG. 5, is also displayed. In this embodiment, an action item owner identification number 410 identifies the assigned owner of the action item. In other embodiments, other forms of identifying an action item owner, such as an action item owner name or photo icon may be used. The action item's state 412 (e.g., completed or in process) is also provided, along with the action item's status 414 with respect to its due date (e.g., overdue). A review identification number 416, which identifies the review that resulted in the action item's creation is provided. Like the action item identification number 410, the review identification number 416 also functions as a URL ink to a web page displaying the details of the review. A description section 418 provides a brief description of the action item. A review type field 420 (e.g., design, tollgate, safety, etc.) provides information on the type of review that resulted in the action item.

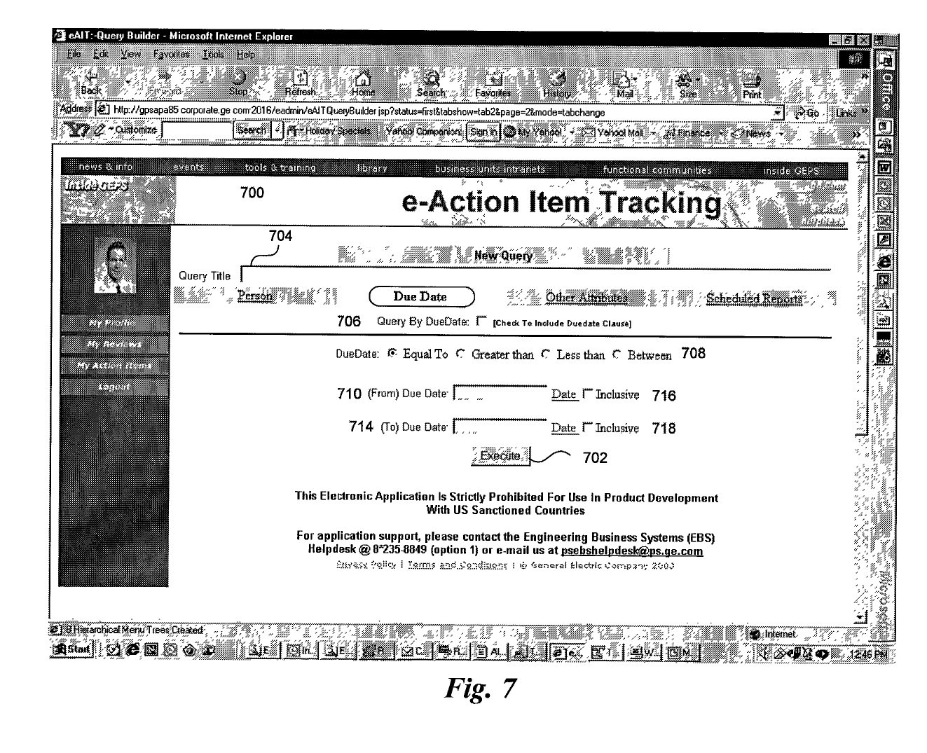

The query report page 400 in this embodiment also includes links to other action item tracking system web pages. For example, if the user selects the query details link 422, it will cause the display of a page containing saved query criteria. The home page link 424, if selected, will cause the display of the user's home page, such as the home page 100 of FIG. 1 or the home page 300 of FIG. 3. Similarly, the cockpit link 426 returns the user to the preferences page of FIG. 7. The user may log out of the action item tracking system using the logout link 428.

FIG. 5 is an illustration of an action item details page. The action item details page 500 includes detailed information for a single action item. The action item details page 500 may be displayed when the user selects an action item identification number link from one of the action item tracking system web pages, such as the action item identification number link 408 of FIG. 4, or the action item identification number link 104 of FIG. 1. A similar page may be available for review details.

FIGS. 6-8 are examples of web pages, or query option pages, that facilitate the creation of custom search queries to search for action items. The user reaches these pages by selecting a build new query link from one of the action item tracking system web pages, such as the build new query link 318 of FIG. 3. The user may create a single query using one or more of the query option pages. FIG. 6 is an example of a search-by-person query option page 600. In this embodiment, the search-by-person query option page 600 is displayed as the default query option page. Using the search-by-person query option page 600, the user may create a custom query to search for action items by indicating the name of one or more of the people associated with the action item.

The search-by-person query option page 600 includes a query title text field 604. This allows the user to save the query under a particular title. The search-by-person query option page 600 also includes several text fields and drop-down menus that allow the user to input search-by-person criteria. For example, to search for action items by the general manager assigned to the action items, the user may select from names of general managers using the general manager drop-down menu 606. Similar drop-down menus are available that allow the user to search for action items by program manager 608, functional manager 610, technical leader 612, and chief engineer 614. The user may also search for action items by assigned owner using the owner drop-down menu 616.

When a selection is made from any of the various drop-down menus, an indication of this selection is displayed in the corresponding selection text area 620. When the user has entered all the desired criteria using the search-by-person query option page 600, the user may then continue on to one of the other query option pages to add additional query criteria. Links to the other query option pages are provided, including search-by-due-date 624 and search-by-other-attributes 626. Additionally, a link 622 to a save query/set execution page is provided.

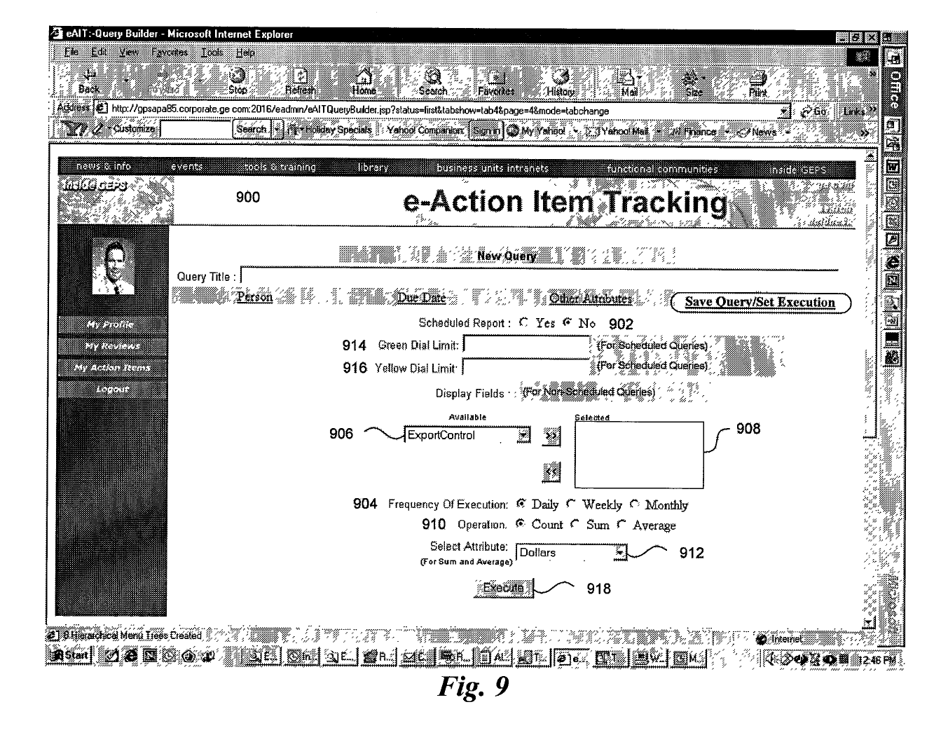

If the user has finished entering query criteria, the user may execute the query by selecting an execute button 618. The query will then return query results in a report containing requested action item information, such as the query results page 400 of FIG. 4. As an alternative to executing the query, the user may save the query so that it executes automatically at a specified frequency. The user may do this by inputting execution frequency indications into a save query/set execution page, such as the save query/set execution page 900 of FIG. 9.

FIG. 7 is an example of a search-by-due-date query option page. Using the search-by-due-date query option page 700, the user may input query criteria to search for action items by assigned due date. If the user has not yet entered a query title from another query option page, the user may enter a query title from the search-by-due-date query option page 700. Otherwise, a previously entered query title is displayed in the query title text field 704. The search-by-due-date query option page 700 includes a query by due date checkbox 706 that the user may select to include a due date clause in the reports generated by the query.

In this embodiment, by selecting one of four radio buttons 708, the user may input criteria to search for action items between two provided due dates (e.g., from date and to date). The user may also input criteria to search for action items with due dates equal to, greater than, or less than one provided due date. In this example, the user has selected the “equal to” indicator. The user next provides a due target due date into either a “from” due date text field 710 or a “to” due date text field 714. If the user selects to search for action items between two due dates, the user inputs target dates into both the “from” due date text field 710 and the “to” due date text field 714. To indicate whether the query results are to include the inputted dates, the user may select a “from” due date inclusive checkbox 716 and/or a “to” due date inclusive checkbox 718.

When the user has entered all the desired criteria using the search-by-due-date query option page 700, the user may then continue on to one of the other query option pages to add additional query criteria. Alternatively, the user may execute the query by selecting the execute button 702. The user may also save the query and provide indications to execute the query automatically at a specified frequency. The user may do this by inputting execution frequency indications into a save query/set execution page, such as the save query/set execution page 900 of FIG. 9.

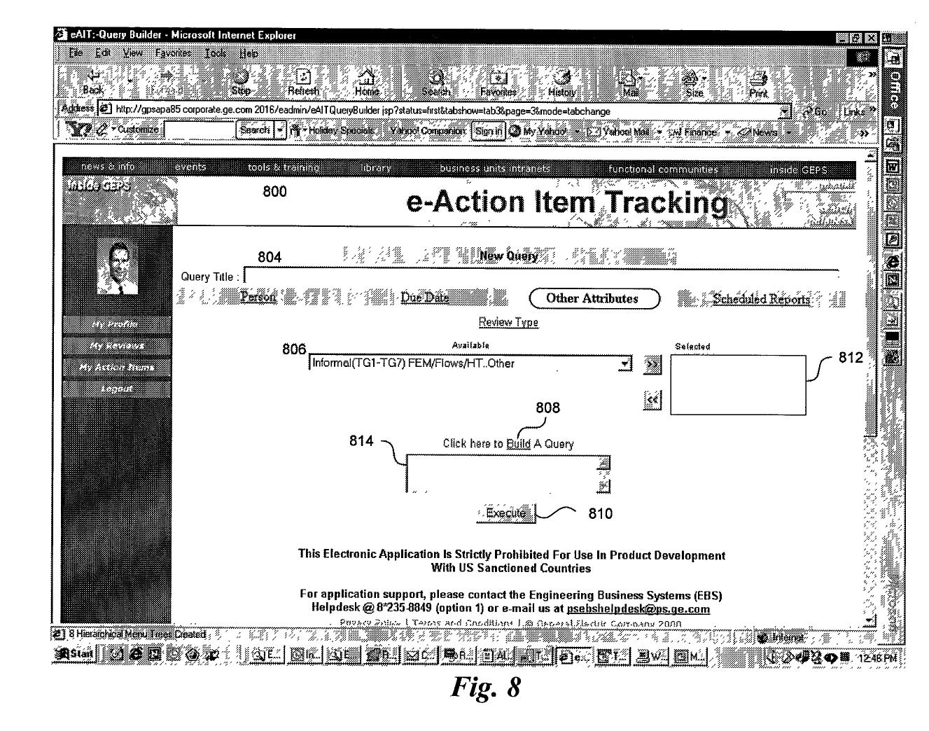

FIG. 8 is an example of a query option page for searching for action items using other attributes. The other attributes query option page 800 includes a query title section 804 that displays the query's title. If the user has not yet entered a title from one of the other query option pages, the user may do so from the other attributes query option page 800. The user may create a narrow query by selecting a review type from the review type drop-down menu 806. For example, a user may select to limit a query to action items generated as part of formal reviews associated with a specific product line. When the user selects a review type, the selection is indicated in a selected text area 812.

The other attributes query option page 800 also includes a build a query link 808. Selection of this link causes the display of a web page containing a user interface through which the user may build a custom query using, for example, key words and Boolean operators such as “and,” “or,” and “not.” After submission, the built query is subsequently displayed in a text area 814 on the other attributes query option page 800. When the user has finished entering criteria into the other attributes query option page 800, the user may continue on to one of the other query option pages to add additional query criteria. The user may also execute the query at this point by selecting an execute button 810. As an alternative to executing the query, the user may provide indications to save the query for execution at a specified frequency. The user may do this by inputting execution frequency indications into a save query/set execution page, such as the save query/set execution page 900 of FIG. 9.

FIG. 9 is an illustration of a save query/set execution page for a user of the action item tracking system in one embodiment. The user accesses the save query/set execution page 900 by selecting a save query/set execution link from one of the action item tracking system's query option pages, such as the save query/set execution link 622 of FIG. 6. Using the save query/set execution page 900, the user may save a query that the user has created using one or more of the action item tracking system's query option pages, such as the query option pages of FIGS. 6-8.

In this embodiment, the user may save a query by designating the query as “scheduled” using scheduled query radio buttons 904. Once designated as scheduled, a query may be saved in the system upon initial execution and will execute automatically at a frequency set by the user using the frequency of execution radio buttons 904 (e.g., daily, weekly, or monthly).

Even if a user does not designate a query as scheduled, the user may provide custom criteria for executing nonscheduled (single instance execution) queries. The user may customize the type of information returned in a query report for a nonscheduled query using a display fields drop-down menu 906. For example, the user may provide indications to include export control information in the query results report. The user's selected display fields are listed in a selected fields text area 908, which is adjacent to the display fields drop-down menu 906.

As described above in the textual description associated with FIG. 3, the user may select to have an operation (e.g., count, sum, or average) performed on an attribute (e.g., dollars, people, risk level, overdue date, action item, date, etc.) that is returned in a query result. For example, the count operator may be selected to count the number of overdue action items returned in a query. Similarly, the sum and average operators may be used to add or average dollar amounts in cost related fields or to add or average some other figure, such as a numerical risk level or the number or action items owned by the various action item owners listed in a query result. Operation radio buttons 910 and a select attribute drop-down menu 912 are provided so that the user may input operation and attribute selections.

In the illustrated embodiment, a user that is interested in addressing high risk action items may select to average the numerical risk associated with the action items returned in a scheduled query. If high-risk items are given a maximum numerical risk of 100 and low risk items are given a minimum numerical risk of 0, the user may designate an average of 60 or above to be high risk.

Accordingly, the user would input a value of 59 into the yellow dial limit text field 912. Similarly, the user may designate an average of 40 or below to be low risk, and would input this value into the green dial limit text field. Once the scheduled query is executed, the user may then view the dial associated with the query from his or her home page. The dial would display the range in which the calculated result for the query falls.

After the user has entered all desired information into the various indicators and text fields of the save query/set execution page 900, the user selects an execute button 920 to execute the query. In this embodiment, if the query is designated as scheduled, selection of the execute button 920 also causes the query to be saved.

While the attributes and operations described in this example relate to overdue action items, one skilled in the art would appreciate various other operations, including non-numerical and Boolean operations, may be performed on almost any attribute or group of attributes associated with query results (e.g., name, status, dollars, description, identification, color, etc.). Additionally, while in the illustrated embodiment, operation results for a scheduled query may be quickly conveyed to the user via dial icons, 306, 308, and 310 containing green, yellow, and red ranges that correspond to an operation result range specified by the user. One skilled in the relevant art, however, would understand that other types of presentation images or icons, besides dials, may be utilized to display or convey operation results. For example, photo icons may be used to indicate a particular person, and action icons such as STOP, BUY and SELL may be used to suggest a particular action.

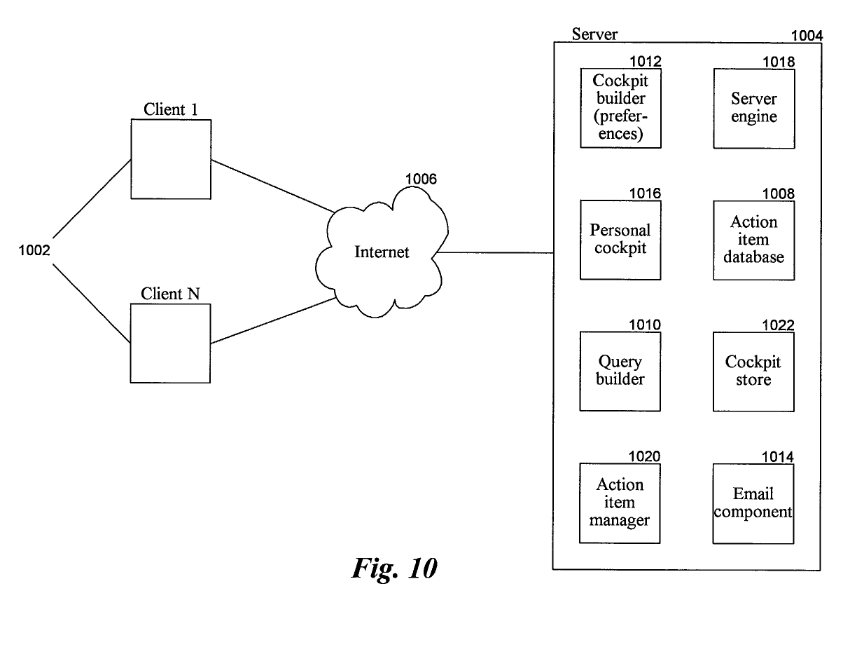

FIG. 10 is a block diagram illustrating an example of components of the action item tracking system. One or more client computers 1002 and a server computer 1004 are interconnected via a public network such as the Internet 1006. The computers may include a central processing unit, memory, input devices (e.g., keyboard and pointing devices), output devices (e.g., display devices and printers), and storage devices (e.g., optical and flash or magnetic disk drives) all not shown in FIG. 10, but well known to those skilled in the relevant art. The memory and storage devices are computer-readable media containing computer instructions that implement the action item tracking system. The client computers may use a browser to access the web pages via the Internet.

The server computer implements the action item tracking system. The server computer includes a server engine 1018, an action item tracking database 1008, and an action item manager 1020. In one embodiment, the server engine receives HTTP requests from the client computer, invokes the appropriate component to service the requests, and sends the HTTP responses indicated by the invoked component. The HTTP responses may include web pages (e.g., HTML documents) for display by the client computer. The server computer also includes a query builder 1010, which allows the user to build custom queries in order to search for action items within the action item tracking database. The query builder 1010 also allows the user to select query options such as query execution frequency. For example, the user may select to have queries executed whenever the user logs in to the action item tracking system, or at a specified frequency such as daily, weekly, or monthly. A cockpit builder tool 1012 allows the user to select custom preferences for displaying quick-view reports on a user's custom home page. The personal cockpit component 1016 generates the user interface that provides access to the saved queries and the quick-view reports generated using the query builder 1010 and the cockpit builder 1012. The cockpit store 1022 stores all the query definitions and custom preferences for each user of the action item tracking system.

The client computers 1002 and the server computer 1004 may communicate via electronic mail. Accordingly, the server computer may include an electronic mail component 1014 to facilitate electronic communication between such computers. While wired connections are shown, the various computers may be connected via wireless connections. Additionally, the term “computer” as generally used herein refers to any data processing devices, including portable computers, palm top computers, personal digital assistants, Internet appliances, cellular or mobile telephones, wearable computers, set-top boxes, etc.

One skilled in the art will appreciate that the concepts of the above action item tracking system can be used in various environments other than the Internet. For example, the concepts can also be used in an electronic mail environment in which electronic mail messages may be used exclusively to build custom queries, report query results, and generate quick-view reports, rather than relying on web-based forms for some aspects of the action item tracking system. Also, various communication channels may be used such as a local area network, a wide area network, or a point-to-point dial-up connection instead of the Internet. The server system may comprise any combination of hardware or software that can support these concepts. In particular, a web server may actually include multiple computers. A client system may comprise any combination of hardware and software that interacts with the server system. The client systems may include television-based systems, Internet appliances, and various other consumer products through which action items may be tracked and action item queries and reports may be generated and executed. Examples of such systems include wireless computers (palm-based, wearable, mobile phones, etc.). Moreover, the concepts of the present invention may be applied to action item tracking systems that are only partially supported by computer systems.

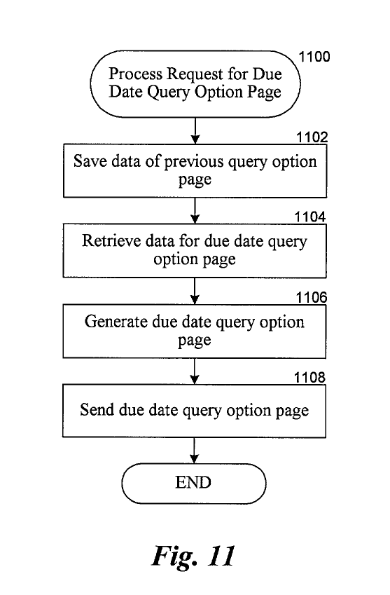

FIG. 11 is a flow diagram illustrating a routine 1100 for processing a request for a search-by-due-date query option page in one embodiment. A similar routine may be used to process requests for other query option pages (e.g., search-by-person, other attributes). In block 1102, the routine saves any information (e.g., query title or query criteria) inputted by the user via another query option page, such as a search-by-person query option page. In this way, users may start entering criteria for a custom query using one query option page and continue entering criteria for the same query using other query option pages. In block 1104, the routine retrieves data for the requested query option page. The data for the query option page may include information defining standardized input fields, as well as selection options (e.g., a list of names or a list of review types). In block 1106, the routine generates the requested query option page. In block 1108, the routine sends the generated query option page to a client computer. Although the query option page described in this embodiment is a web page, one skilled in the relevant art would understand that other ways of providing the same information may be used without departing from the invention, such as an electronic mail message or a display on a personal digital assistant.

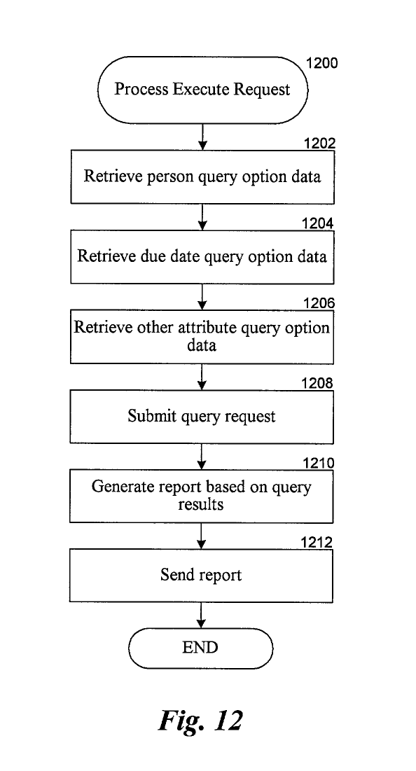

FIG. 12 is a flow diagram illustrating a routine 1200 for processing an event to execute a query in one embodiment. The event may be generated, for example, when a query is scheduled to execute, or alternatively, when the user selects an execute button from a query option page, such as the execute button 618 of the search-by-person query option page 600 of FIG. 6. In block 1202, the routine retrieves saved custom query data inputted using a search-by-person query option page. In block 1204, the routine retrieves saved data inputted using a search-by-due-date query option page. In block 1206, the routine retrieves saved data inputted using an other attributes query option page. In block 1208, the routine submits the query request for execution. In block 1210 the routine generates a report based on the query results. In block 1212, the routine sends the generated report to the client computer. In another embodiment, this report may be generated in condensed form suitable for display on the user's home page, or alternatively, in another format, such as an electronic mail message.

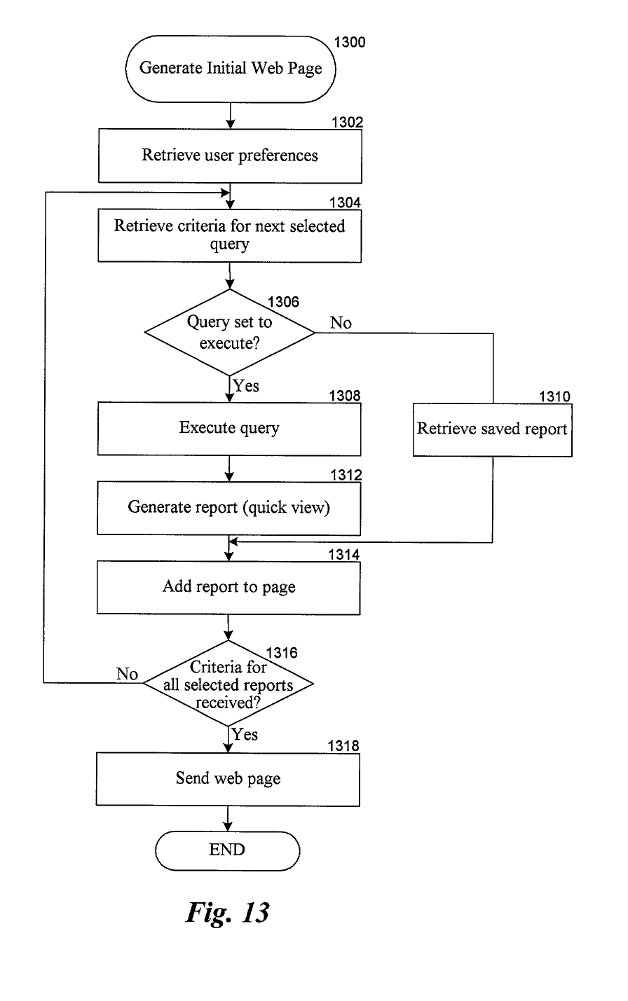

FIG. 13 is a flow diagram illustrating a routine 1300 for generating a page to display reports resulting from executed queries. This page may be displayed as a user home page, such as the user home page 300 of FIG. 3. In block 1302, the routine retrieves user preferences for displaying information on the page. In one embodiment, the user preferences indicate one or more saved queries to be displayed on the page. In block 1304, the routine retrieves criteria for the first selected query. In decision block 1306, if the retrieved criteria for the first selected query indicate that the query is scheduled for execution, the routine continues at block 1308 where the routine executes the query. Else, the routine continues at block 1310, where the query retrieves a saved report generated when the query was last executed. From block 1310 the routine continues at block 1314. If the query is executed (block 1308) the routine continues at bock 1312, where the routine generates a condensed (e.g., quick-view or flash) report containing information from the executed query. In block 1314, the routine adds the generated condensed report to the page. In decision block 1316, if the criteria have been retrieved for all selected queries, the routine continues at block 1318, where the routine sends the page to the client computer. Else the routine loops back to block 1304, where the routine retrieves the criteria for the next selected query.

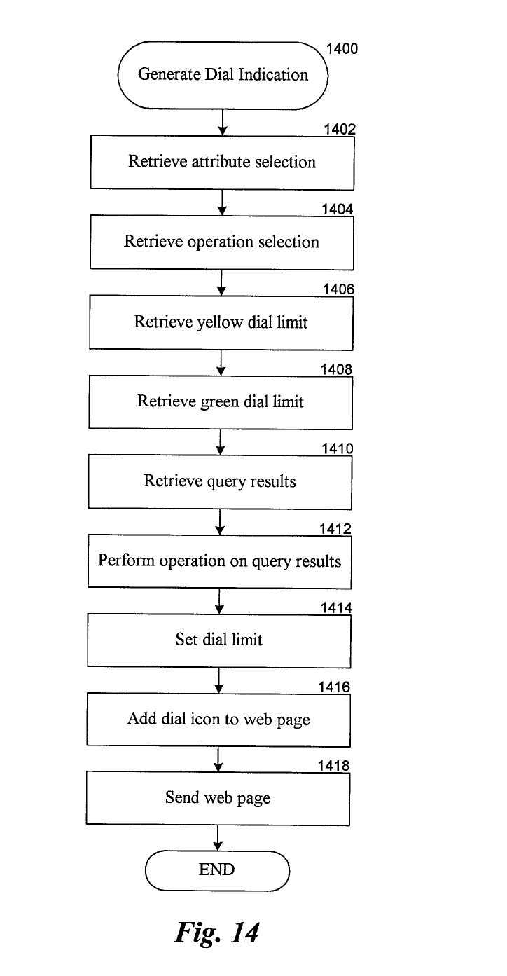

FIG. 14 is a flow diagram illustrating a routine 1400 for generating a dial indication for an executed query. In one embodiment, a dial indication may be displayed with each query report (e.g., flash report) displayed on the user's home page. In block 1402, the routine retrieves an attribute selection. In block 1404, the routine retrieves an operation selection, which indicates the operation to be performed on the selected attribute. In block 1406, the routine retrieves a yellow dial limit indication, indicating the uppermost limit of a middle range. In block 1408, the routine retrieves a green dial limit indication, indicating the uppermost limit of a lower range. In one embodiment, the user may provide the attribute selection, the operation, the yellow dial limit, and the green dial limit while creating the query using a query option page. In block 1410, the routine retrieves query results. The query results may be saved immediately after the query is executed. In block 1412, the routine performs the indicated operation on the retrieved query results. In block 1414, the routine sets the dial limits according to the value returned from the operation. For example, if the result exceeds the yellow dial limit value, the dial is set at the high range (e.g., red). In block 1416 the routine adds the dial icon to the web page. In one embodiment, the dial is displayed adjacent to the corresponding condensed report, as illustrated in the home page 300 of FIG. 3. The dial may also contain information regarding the number of action items in the report. The dial may be used as a link to a more detailed version of the report, as illustrated in the report page 400 of FIG. 4.

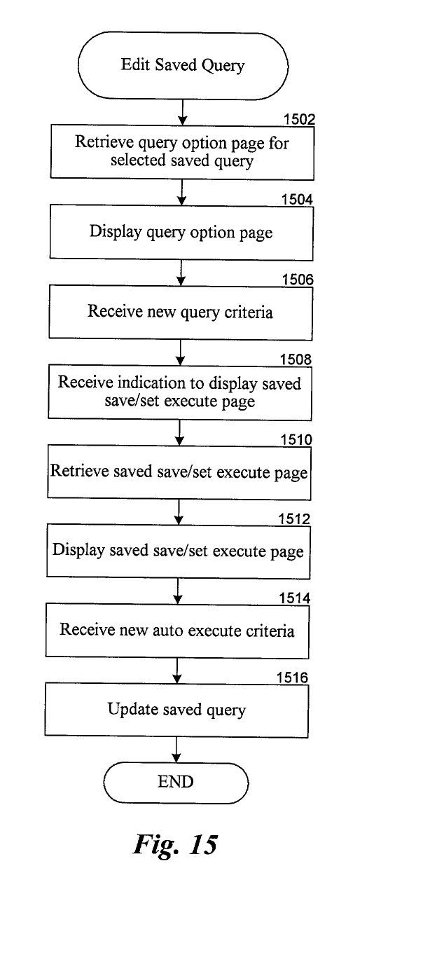

FIG. 15 is a flow diagram illustrating a routine 1500 for editing a saved query in one embodiment. In block 1502, a saved query option page for a selected saved query is retrieved. In block 1504, the saved query option page for the selected saved query is displayed. Using this page, the user can edit the information previously entered into the text fields, radio buttons, checkboxes, and drop-down menus of the query option page. In block 1506, the routine receives the new query criteria entered by the user. In block 1508, the routine receives an indication to display the saved save query/set execution page that corresponds to the saved query. In block 1510, the routine retrieves the saved save query/set execution page. In block 1512 the routine displays the saved save query/set execution information. In block 1514 the routine receives new set execution criteria (e.g., execution frequency and display field criteria) for the saved query. In block 1516, the routine updates the saved query.

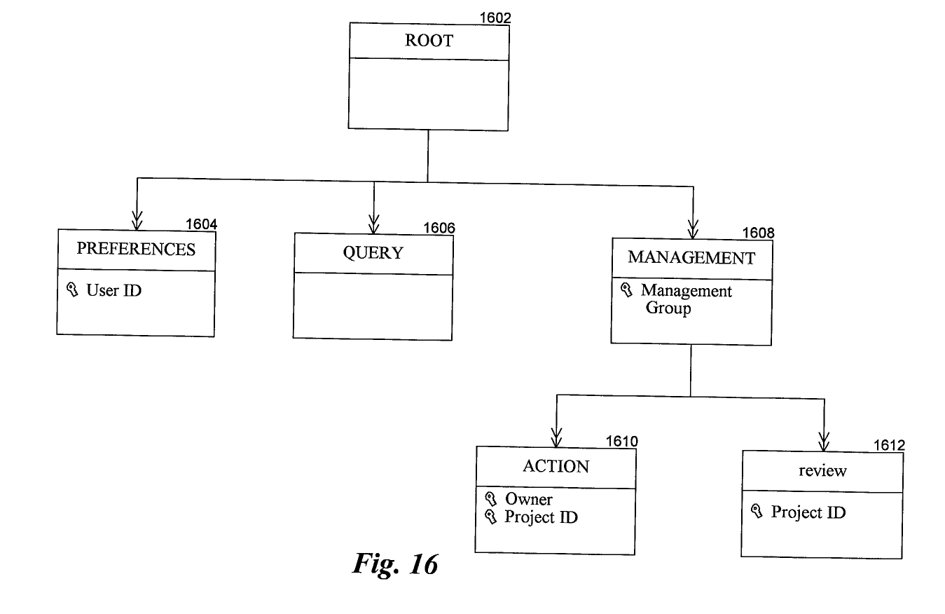

FIG. 16 is a block diagram illustrating data structures of a sample database in one embodiment. The database includes a root table 1602, a preferences table 1604, a query table 1606, a management table 1608, an action item table 1610, and a review table 1612. These tables represent a logical organization of the data. One skilled in the art would appreciate that varying physical organizations of the data may be used. The management table 1608 may contain various types of general project information including project title, export control information, and security classification information. In one embodiment, the management table 1608 is related to the root table 1602 by a management group identification number. The preferences table 1604 and the query table 1606 are provided to store values for user settings, query settings, and previous flash report values, respectively. Fields in the preferences table 1604 and the query table 1606 are related back to the root table by a user identification number. The preferences table 1604 may, for example, contain information relating to the display of items on the user's custom home page. The query table 1608 may, for example, contained information relating to the saved queries generated by users of the action item tracking system, including scheduled query execution frequency data.

The review table 1612 stores review information such as review agenda, review type, review arrangements, review meeting location, etc. Each review may have one or more action items that are stored in an action item table 1610. The action item table will include information pertaining to the action item owner and a description of the action item. Fields in the action item table 1610 and the review table 1612 are related to the management table by a project identification code or an owner identification code.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1] A method in a computer system for retrieving stored action item information, the method comprising:
providing the stored information;
receiving from a user criteria for generating custom reports;
storing the received criteria;
generating a report based on stored information that matches the stored criteria;
sending to the user a condensed version of the generated report; and
when the user requests more detailed information associated with the report, sending to the user a complete version of the generated report.

2] The method of claim 1 wherein the report is generated at a frequency indicated by the user.

3] The method of claim 1 wherein the report is generated each time the user logs in to the system.

4] A computer readable medium containing instructions to perform a method comprising:
providing stored action item information;
receiving from a user criteria for generating custom reports;
storing the received criteria;
generating a report based on stored information that matches the stored criteria;
sending to the user a condensed version of the generated report; and
when the user requests more detailed information associated with the report, sending to the user a complete version of the generated report.

5] The computer-readable medium of claim 4 wherein the report is generated at a frequency indicated by the user.

6] The computer-readable medium of claim 4 wherein the report is generated each time the user logs in to the system.

7] A computer system for generating reports containing information related to action items comprising:
means for storing action item information;
means for receiving from a user criteria for generating custom reports containing the stored action item information;
means for storing the received criteria;
means for generating a custom report, the report based on stored information that matches the stored criteria;
means for generating a condensed version of the report, wherein the condensed version includes a link to a complete version of the report;
means for sending the condensed version of the report to the user; and
means for sending the complete version of the report to the user.

8] The computer system of claim 7 further comprising means for generating the condensed version of the report each time that the user logs in to the computer system.

9] The computer system of claim 7 further comprising means for generating the custom report each time that the user logs in to the system.

10] A method in a computer system for reporting stored action item information, the method comprising:
generating a first report at a frequency defined by a user and based on criteria defined by the user;
when a user logs in to the computer system, generating a second report;
generating a display description containing indications of the first and second reports;
sending the display description containing the indications of the first and second reports.

11] The method of claim 10 wherein the second report contains indications of action items owned by the user.

12] The method of claim 10 wherein the second report is based on criteria defined by the user.

13] The method of claim 10 wherein the indications of the first and second reports are a condensed version of the first and second reports.

14] The method of claim 13 wherein the indications of the first and second reports include links to complete versions of the first and second reports.

15] The method of claim 14 including, upon request by the user, sending indications containing complete versions of the first and second reports.

16] The method of claim 10 wherein the indications of the first and second reports are a complete version of the first and second reports.

17] A computer-readable medium containing instructions to perform a method comprising:
generating a first report at a frequency defined by a user and based on criteria defined by the user;
when a user logs in to the computer system, generating a second report;
generating a display description containing indications of the first and second reports;
sending the display description containing the indications of the first and second reports.

18] The computer-readable medium of claim 17 wherein the second report is based on criteria defined by the user.

19] The computer-readable medium of claim 17 wherein the indications of the first and second reports are a condensed version of the first and second reports.

20] The computer-readable medium of claim 17 wherein the indications of the first and second reports are a complete version of the first and second reports.

21] A computer system for generating reports containing action item information, comprising:
means for generating reports based on criteria defined by the user;
means for receiving a frequency for generating a first report, the frequency defined by a user;
means for generating a second report;
means for generating a display description containing indications of the first and second reports;
means for sending the display description containing the indications of the first and second reports.

22] The computer system of claim 21 wherein the indications of the first and second reports are a condensed version of the first and second reports.

23] The computer system of claim 21 wherein the indications of the first and second reports are a complete version of the first and second reports.

24] A method in a computer system for presenting stored information, the method comprising:
receiving from a user a query specification for a query, the query specification specifying stored information to be retrieved by the query;
receiving from a user a presentation image specification corresponding with an attribute of the stored information retrieved by the query;
executing the query to retrieve the stored information defined by the query specification;
generating a report based on the retrieved information;
analyzing the retrieved information based on the presentation image specification;
selecting a presentation image based on an evaluation of the query; and
displaying the selected presentation image.

25] The method of claim 24 including displaying a description of the generated report with the selected presentation image.

26] The method of claim 25 wherein the displayed description of the generated report is a condensed version of the generated report.

27] The method of claim 25 wherein the displayed description of the generated report is a complete version of the generated report.

28] The method of claim 24 wherein the user specifies information to be displayed in the presentation image, the information derived from the retrieved information.

29] The method of claim 27 wherein the specified information is a number of action items contained in the report.

30] The method of claim 24 wherein the selected presentation image is a picture of a person associated with the information contained in the report.

31] The method of claim 24 wherein the selected presentation image is a dial with a needle pointing to a red range.

32] The method of claim 24 wherein the selected presentation image is a dial with a needle pointing to a yellow range.

33] The method of claim 24 wherein the selected presentation image is a dial with a needle pointing to a green range.

34] The method of claim 24 wherein the selected presentation image serves as a link that causes display of a complete version of the report when selected by the user.

35] A computer-readable medium containing instructions for controlling a computer to generate reports containing action item information by a method comprising:
receiving from a user a query specification and an icon specification, the query specification specifying stored information to be retrieved by a query, the icon specification corresponding with an attribute of the stored information retrieved by the query;
executing the query to retrieve the stored information defined by the query specification;
generating a report based on the retrieved information;
analyzing the retrieved information based on the icon specification;
selecting an icon based on an evaluation of the query; and
displaying the selected icon.

36] The computer-readable medium of claim 36 including displaying a description of the generated report with the selected presentation image.

37] The computer-readable medium of claim 36 wherein the user specifies information to be displayed in the presentation image, the information derived from the retrieved information.

38] The computer-readable medium of claim 36 wherein the selected presentation image is a picture of a person associated with the information contained in the report.

39] A computer system for generating reports containing action item information comprising:
means for receiving from a user a query specification and an icon specification, the query specification specifying stored information to be retrieved by a query, the icon specification corresponding with an attribute of the stored information retrieved by the query;
means for executing the query to retrieve the stored information defined by the query specification;
means for generating a report based on the retrieved information;
means for analyzing the retrieved information based on the icon specification;
means for selecting an icon based on an evaluation of the query; and
means for displaying the selected icon.

40] The computer system of claim 39 including displaying a description of the generated report with the selected presentation image.

41] The computer system of claim 39 wherein the user specifies information to be displayed in the presentation image, the information derived from the retrieved information.

42] The computer system of claim 39 wherein the selected presentation image is a picture of a person associated with the information contained in the report.

43] The computer system of claim 39 wherein the selected presentation image serves as a link that causes display of a complete version of the report when selected by the user.

44] A method in a computer system for retrieving action item information from an information store, the stored information including indications of actions items, the method comprising:
providing a plurality of information categories for storing the indications of action items, the plurality of information categories including categories for persons associated with actions and categories for dates associated with actions;
providing a plurality of query creation options for inputting criteria for generating custom reports, the query creation options associated with one or more of the provided information categories;
receiving from a user criteria for generating custom reports, the criteria including indications associated with at least one of the provided query creation options and indications of a frequency for executing the custom reports;
storing the received criteria;
executing a query based on the received criteria for generating custom reports;
generating a report, based on the information retrieved by the query; and
sending to the user the generated report.

45] A method in a computer system for retrieving stored information from an information store, the method comprising:
receiving from a user criteria for executing a custom query, the criteria including indications for retrieving information from the information store and a scheduling frequency for executing the custom query,
executing the custom query to retrieve the stored information defined by the query specification;
generating a report based on the retrieved information;
receiving from the user an indication to perform an operation on a selected attribute, the attribute contained within the generated report;
performing the operation on the selected attribute in order to obtain a result;
receiving from the user an uppermost value for a middle range and an uppermost value for a lower range, the received values defining a high range, a medium range, and a low range for the result;
adding to the generated report an indication of the range in which the result falls; and
sending to the user the generated report.

46] A method in a computer system for reporting stored action item information, the method comprising:
providing the stored information;
receiving from a user criteria for generating custom reports, the criteria including a query specification for specifying stored information to be included in the reports, a frequency for generating the reports, and an icon specification corresponding with an attribute of the stored information included in the reports;
storing the received criteria;
generating a first report at a frequency defined by a user, the first report based on the query specification;
analyzing the first report based on the icon specification;
selecting an icon based on an evaluation of the query;
when a user logs in to the computer system, generating a second report;
sending to the user a display description containing a condensed version of the first and second reports, the display description of the first report including the selected icon; and
when the user requests more detailed information associated with the reports, sending to the user a complete version of the reports.

47] A computer-readable medium containing instructions to perform a method comprising:
providing stored action item information;
receiving from a user criteria for generating custom reports, including a query specification for specifying stored information to be included in the reports, a frequency for generating the reports, and an icon specification corresponding with an attribute of the stored information included in the reports;
storing the received criteria;
generating a first report at a frequency defined by a user and based on criteria defined by the user;
analyzing the first report based on the icon specification
selecting an icon based on an evaluation of the query;
when a user logs in to the computer system, generating a second report;
sending to the user a condensed display description of the first and second reports, the condensed display description of the first report including the selected icon; and
when the user requests more detailed information associated with the reports, sending to the user a complete version of the reports.

48] A computer system for tracking and retrieving action item information comprising:
means for receiving from a user criteria for generating custom reports, including a query specification for specifying stored information to be included in the reports, a frequency for generating the reports, and an icon specification corresponding with an attribute of the stored information included in the reports;
means for storing the received criteria;
means for generating a first report at a frequency defined by a user and based on criteria defined by the user;
means for analyzing the first report based on the icon specification;
means for selecting an icon based on an evaluation of the query;
means for when a user logs in to the computer system, generating a second report;
means for sending to the user a condensed display description of the first and second reports, the condensed display description of the first report including the selected icon; and
means for sending a complete version of the first and second reports.
